(19) United States
(12) Patent Application Publication
(10) Pub. No.: US 2023/0073427 A1
(43) Pub. Date: Mar. 9, 2023

(54) DECENTRALIZED HARD EXCHANGE

(71) Applicant: Protoblock, Inc., Walnut Creek, CA (US)

(72) Inventor: Yehuda Berg, Walnut Creek, CA (US)

(21) Appl. No.: 17/712,833

(22) Filed: Apr. 4, 2022

Related U.S. Application Data
(60) Provisional application No. 63/170,916, filed on Apr. 5, 2021.

(51) Int. Cl. G06Q 40/04; G06Q 20/38; G06Q 20/06

(52) U.S. Cl. CPC G06Q 40/04; G06Q 20/389; G06Q 20/0658

(57) ABSTRACT

A method includes receiving, on a main chain, a block including multiple transactions. The method includes determining, on a side chain, the order of the transactions in the block based on a bidding process and delivering an amount of currency based on the order of the transactions.

### CROSS-REFERENCE TO RELATED APPLICATION

This application claims priority to and the benefit of U.S. Provisional Patent Application No. 63/170,916 filed Apr. 5, 2021.

### TECHNICAL FIELD

The disclosed teachings relate generally to a distributed autonomous platform.

### BACKGROUND

Distributed computing has emerged as a promising solution to the inherent drawbacks of standalone computing. Bitcoin is an example of a distributed autonomous cryptocurrency system that provides a pragmatic engineered solution for arriving at a consensus in the face of trust and timing problems encountered in distributed networks. Decentralized exchanges for trading securities can also be implemented in a distributed network. Such exchanges can only support securities of a size too small to be practical compared to conventional centralized exchanges. As such, centralized exchanges remain the only practical means for trading securities.

### BRIEF DESCRIPTION OF THE DRAWINGS

Detailed descriptions of implementations of the present invention will be described and explained through the use of the accompanying drawings.

FIG. 1A is a flowchart depicting a process for a consensus system on order dependent protocols.

FIG. 1B shows frontrunning in an SBFT blockchain.

FIG. 2 shows an overview of a hard exchange.

FIG. 3 shows example activity on an exchange.

FIG. 4 shows properties of a centralized exchange.

FIG. 5 shows properties of a decentralized exchange.

FIG. 6 shows an overview of a DeFi exchange.

FIG. 7 shows an overview of DEXchain.

FIG. 8 shows an example exchange.

FIG. 9 illustrates DEXchain implemented with bitcoin.

FIG. 10 illustrates the DEXchain that satisfies the criteria of a hard exchange.

FIG. 11 shows an overview of legacy blockchain technology, such as DeFi.

FIG. 12 shows an overview of an embodiment.

FIG. 13 shows an overview of a central limit order book of an embodiment.

FIG. 14 shows features of an embodiment.

FIG. 15A shows an overview of transaction ordering.

FIG. 15B shows an overview of how transaction ordering is handled according to an embodiment.

FIG. 16A shows an overview of price discovery.

FIG. 16B shows an overview of how price discovery is handled according to an embodiment.

FIG. 17A shows an overview of futures contracts delivery.

FIG. 17B shows an overview of how futures contracts are delivered according to an embodiment.

FIG. 18 shows features of DexBitcoin according to an embodiment.

FIG. 19 shows features of DexBitcoin according to an embodiment.

FIG. 20 shows features of DexBitcoin according to an embodiment.

FIG. 21 shows features of DexBitcoin according to an embodiment.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Adversary protocols, where the ordering of transactions within a block for processing has an economic effect, will reach consensus using the highest bid block-order processing method. This patent application makes use of concepts that appear in U.S. Pat. No. 10,608,825, titled “Decentralized exchanges in a distributed autonomous platform,” filed Apr. 21, 2017, which claims the benefit of U.S. Provisional Patent Application No. 62/325,647, filed on Apr. 21, 2016, and claims the benefit of U.S. Provisional Patent Application No. 62/325,637, filed on Apr. 21, 2016, and claims the benefit of U.S. Provisional Patent Application No. 62/325,607, filed on Apr. 21, 2016, each of which are incorporated as Exhibit A in their entireties for all purposes.

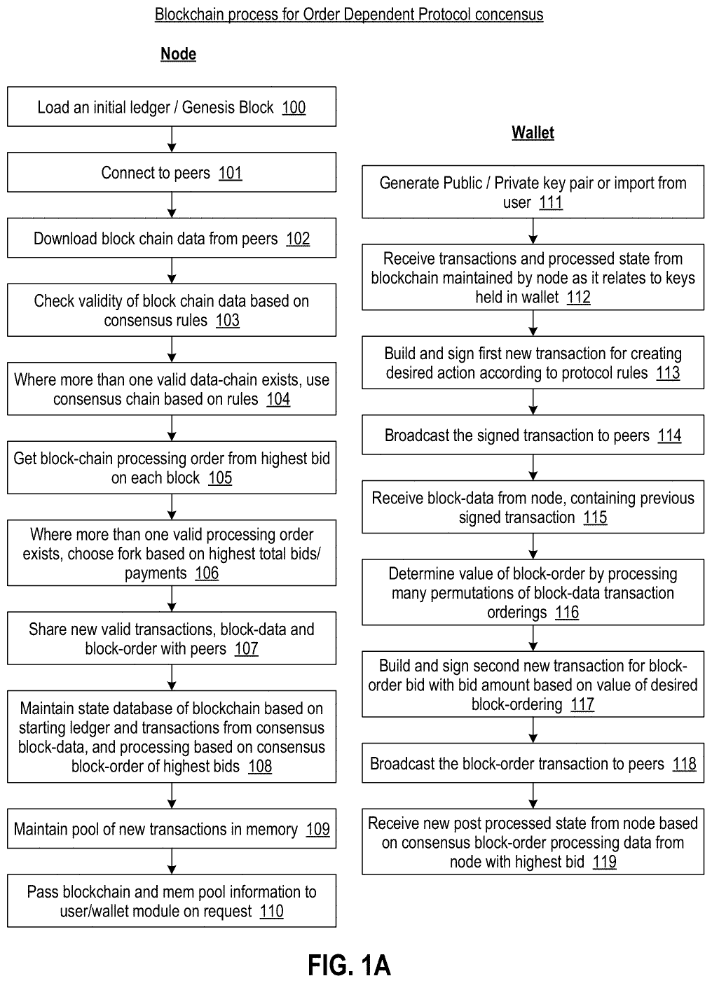

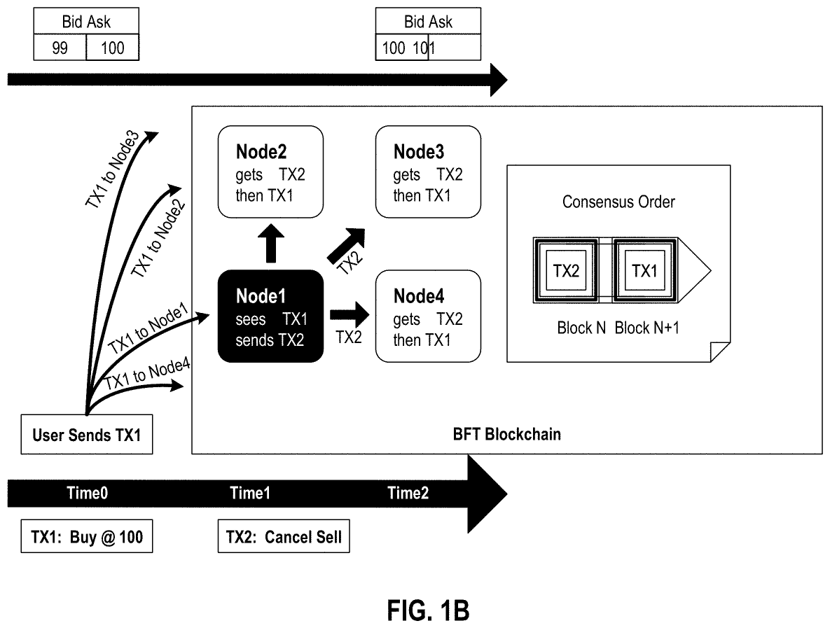

FIG. 1A is a flowchart depicting a process for a consensus system on order dependent protocols. FIG. 1B shows frontrunning in an SBFT blockchain, where Node 1 can read the user's transaction, TX1, and front run the transaction with TX2, creating Adverse Selection Risk for the user. In one implementation, the consensus blockchain software application contains two modules: a node and a wallet. The node and wallet perform different functions in the process of consensus for transaction-order-dependent protocols. The node is a replica of all nodes in the network, and is responsible for consensus, verification and state database updates, while the wallet is tied to a user or entity based on its stored public/private key pairs.

At 100, the node loads an initial ledger, such as a Genesis Block. Each blockchain and future state is uniquely identified by its GenesisBlock hash and subsequent block hashes, that are verified according to the protocol rules and consensus. At 101, the node connects to peers, within the network. These peers can be supplied by an oracle, in the case of permissioned blockchain, or discovered in the case of open public blockchains. A node running for the first time must synchronize and process all data from initial ledger to the present. At 102, the node downloads blockchain data from its peers, there the data includes peer lists and historical blocks.

At 103, the node checks the validity of the block-data, the raw pre-processed blocks is performed, based on consensus rules. At 104, when multiple valid block-data chains exist, consensus rules, such as longest chain rules, or stake weight rules are used to determine consensus data-chain.

At 105, the node verifies and determines the transaction processing order from the order sequence described in the block-order transaction, with the highest bid for each block height. At 106, when multiple competing valid processing orders exist, the consensus fork is chosen based on the highest total bids/payments accumulated since the Genesis.

Node software then processes the block-data transactions in an order sequence described in the block-order transaction with the highest bid at each block height.

At 107, once the node is caught up with history and is on the same consensus chain as its peers, it will share all new transactions, block-data blocks and block-order transactions with its peers.

At 108, the node software maintains a state database which is deterministic based on the initial ledger, and block-data, generated by processing each transaction through the consensus software in the order determined by the block-order with the highest bid at each block.

At 109, the node software also maintains a pool of valid, yet to be processed transactions in its memory. At 110, the node will pass data from the blockchain and the mempool to a wallet module, usually running in parallel on the same machine.

At 111, the wallet generates the public/private key pair or imports it from the user. At 112, the wallet receives transactions and processed state from the blockchain maintained by the node as it relates to keys held in the wallet. At 113, the wallet builds and signs a first new transaction for creating a desired action according to protocol rules. At 114, the wallet broadcasts the signed transaction to peers. At 115, the wallet receives block-data from the node, containing previous signed transaction. At 116, the wallet determines the value of the block-data transaction ordering. At 117, a second new transaction is built and signed for a block-order bid with a bid amount based on a value for desired block ordering. At 118, the block-order transaction is broadcast to peers. At 119, the wallet receives a new post processed state from the node based on consensus block-order processing data from the node with the highest bid.

### Hard Exchange

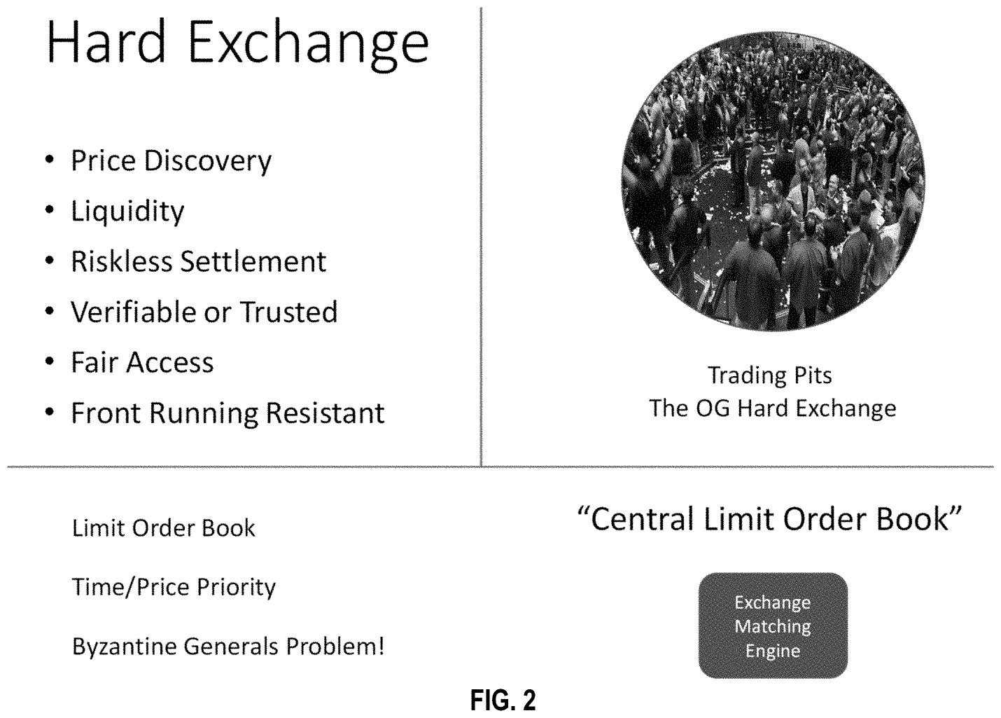

FIG. 2 shows an overview of a hard exchange. A feature of the hard exchange is price discovery. The final arbiter of price for two risky assets, that would be price discovery.

Liquidity: if you have price discovery, then you want liquidity, so as to determine the most valid price.

Riskless settlement: you want to be in a safe space and know that when you make a trade, it's guaranteed to settle.

Verifiable or trusted: if the exchange is decentralized, you want to be verifiable. If it's centralized, the exchange needs to be trusted.

Fair access: everyone must have access or potential access to the same exchange place, where they could hire a broker of go themselves, and all liquidity comes together to find the best price and to make trades.

Front running resistance: this is not necessarily specific to decentralized exchanges. There are also some centralized exchanges, not necessarily in the bitcoin markets but in the equity markets, where there are front-running issues.

What are some early examples of hard exchanges? One of the original hard exchanges is going to be the trading pits in Chicago.

Suppose Bob is a trader in the pits. He sees Alice on the other side of the pit. Bob wants to buy a hundred contracts of corn. Alice says sold. They can look at each other, write down the transaction, and it's filled. There's no front running and no asynchronous communication. The trade occurs in person and in a safe space. Both parties understand the settlement, so it's trusted and verifiable. Everyone in the pit has access, and the exchange is front-running resistant because everyone can see everything happening in front of them. If you're strong and big and you get yourself in the right position, it'll be hard for someone to front run you. That's the chaotic trading pits.

Now we move to electronic exchanges. Imagine the first electronic exchange wanted to create a limit order book. We go from the pits where it's just screaming out bid and asks, and we want to create a fair, time price priority.

For example, let's say a person sends a 100 bid to the exchange, so they would be first. The next person says 100 bid, and they would be second. If a third person somebody wants to go on top of the other two, that third person would have to bid at 101 and create a limit order book.

It turns out we have the Byzantine Generals problem even on a centralized exchange. Even when using computer science techniques like distributed computing, multi-processor, or even multi-threaded, it turns out that the state could not keep up, even between threads. So you wouldn't be able to share state inside the limit order book.

The term central limit order book is not just a centralized exchange. It's actually a single thread on a single server that does the matching for every single symbol on all these exchanges. It's the exchange matching engine, and it's centralized even within the centralized exchange on a single thread.

There are three phenomena that often occur in live markets, such as bitcoin markets. First, the same exact quantity tends to trade in pairs at different prices over and over. The strategy behind this will be discussed below.

The next item is the flashing of orders. What happens in this case is that bids show up and immediately disappear. Often there are trading bots that employ this practice of placing bids that never get filled because they are always canceled in less than a second. We want to understand what is going on here.

The third thing we want to discuss is the amounts or the quantities inside the book. We see that they often come in pairs or are reused repeatedly.

So these are three phenomena that we see. The most interesting one is the flashing of orders. The second one is the duplications of the fills, and the third one is the reuse of the amounts.

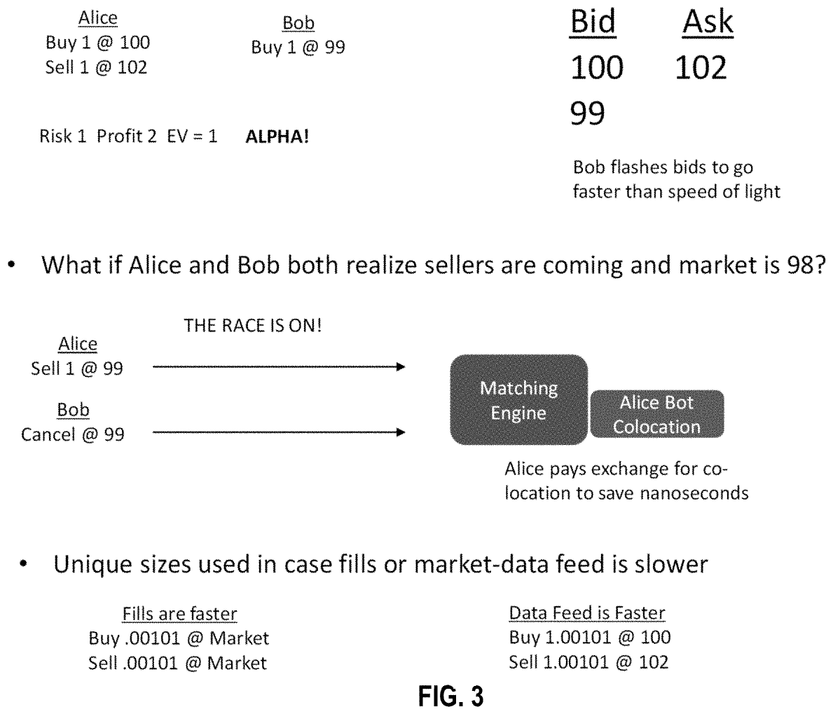

FIG. 3 shows example activity on an exchange that illustrates these phenomena. Alice is a market maker. She puts a buy 1 at 100 and a sell 1 at 102. In other words, she bids 100, asks 102. Her objective is to buy and sell to net 2 dollars. However, as shown, Bob comes in and he puts a bid at 99.

If someone sells at the market to Alice at 100, then Alice is in the perfect position because at any moment in time, Alice could turn around and sell 99. Thus she is only risking one dollar. Alice is long at 100, offering 102. If someone comes at that moment an places a market order, Alice gets 102, netting 2 dollars. Otherwise, she sells at 99 and she loses one dollar. Her expected value is 1. This is alpha.

How do you have 3,000 profitable days in a row in a volatile market? By taking no risk at all, like Alice. How do we know there's no risk here? What if Bob cancels? Alice has to be sure that she could get out by selling to Bob. Note it would be even better for Alice if there were other bids of 100 on top of Alice, so she would have no risk.

What if Alice and Bob both realize at the same time that the market value is 98, that the market's moving down two ticks? Alice would want to sell at 99 and only take a one dollar loss, and Bob wants to cancel his bid. The race is on.

This race happens over and over, thousands of times a minute, and is the most classic race in high frequency trading? Who's going to win? Whoever gets the matching engine first wins.

Alice has a trick up her sleeve. Alice's bot is co-located at the matching engine at the exchange. Alice pays the exchange millions of dollars to co-locate to save nanoseconds for this exact reason, so she can hit the bid before Bob can cancel it.

In order for Bob to win, if Alice is closer to the matching engine, he needs to go faster than the speed of light. How is it possible to go faster than the speed of light? By flashing his bids.

The only way to go faster than the speed of light is to do nothing. If doing nothing creates an action in a distant place, then Bob is actually going faster by not doing anything.

When Bob sends an order to buy one at 99, as soon as he sends the order he's going to try to figure out if there is selling pressure coming in from the market.

However, while he's looking and before he gets an answer, he's going to cancel that 99. If information comes back that there's no selling pressure, he sends the bid again, starts looking for the information again, and cancels again. If information comes in that the market is about to drop, Bob doesn't put the 99 bid back. Not replacing his bid is a negative action. Thus if Alice tries to sell at 99, Bob's bid is already gone. This example illustrates the reason for flashing bids. It gets more complicated in real world markets, but this points to the sophistication of exactly what's happening at that level.

Next, there were two other phenomena, the doubling of fills and the usage of amounts. Every exchange has two feeds: the market data feed and the fill feed. From the perspective of a trading bot, there can be two situations.

First, for a particular exchange, the fills are faster. if the fills are faster, that fact can be leveraged to obtain the market data by buying and selling at the same price. If the orders are being filled, then those fills represent the bid/ask of that market.

On the other side, if the market data feed is faster, then a trader wants to use the public market data feed to get fills before the fill feed comes in. The time difference is on the order of microseconds or nanoseconds. By using and reusing unique amount sizes, a bot could look at the public data feed to identify their fills faster than the fill feed. This example provides insight into how the market has evolved.

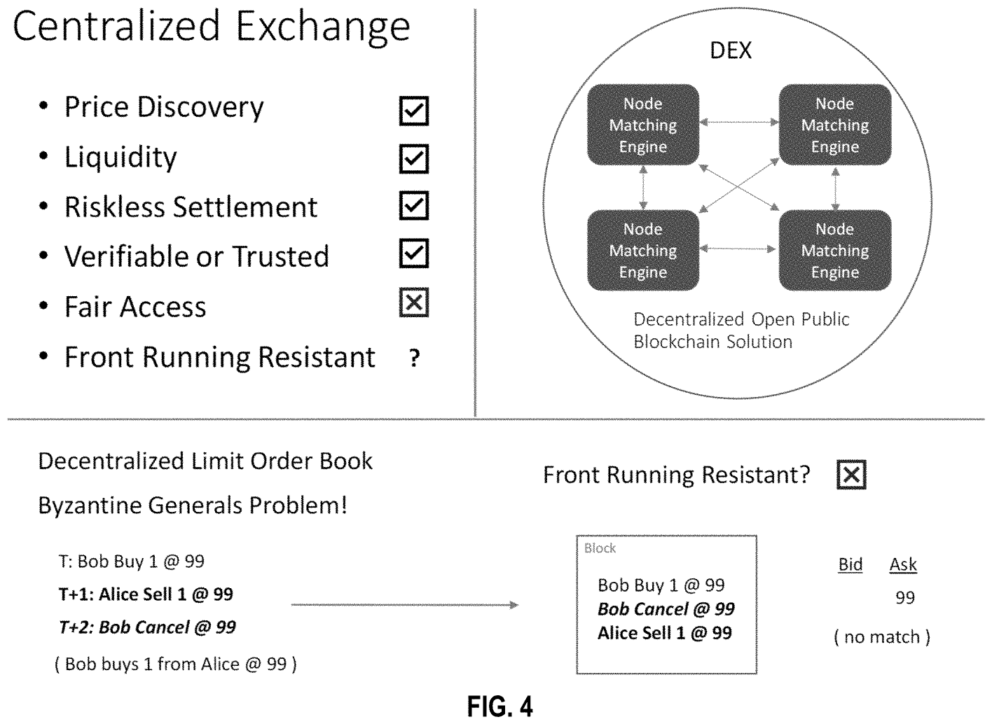

FIG. 4 shows properties of a centralized exchange as described in the example in FIG. 3. Is it a hard exchange?
Price Discovery: there is price discovery because there are limit order books and everyone's coming to that same place.
Liquidity: yes
Riskless settlement: yes, because in the context of the centrali
Verifiable or trusted: yes

However there is no fair access. Not everyone has access to the co-location. Some traders are priced out, while special deals to co-locate exist for other traders. Exchanges are now making more money from selling co-location than from just the trading fees themselves. Accordingly, this centralized exchange is no longer fair access.

Front-running resistance is not necessarily applicable on bitcoin centralized exchanges, but in the equity and NBBO exchanges it does become an issue.

How to fix fair access? One solution is a distributed blockchain protocol. As illustrated in FIG. 4, every node is a matching engine. There's no centralized exchange, so there's no co-location, and no fair access issues.

However, this brings decentralized limit order books, which brings up the Byzantine Generals problem. This is different than the bitcoin double spend problem—this is a front running problem, which bitcoin doesn't solve. Double spends are mutually exclusive from front-running.

The issue is that if multiple sequences are valid, then it's impossible to tell what happened first.

For example, at node A, the order received is:
1) A buy 1 by Bob at 99,
2) A sell 1 by Alice at 99, and
3) A cancel by Bob, which is now too late.

So at Node A, the mempool shows that Bob buys one from Alice.

But at the block, things have changed. Now it says:
1) A buy 1 by Bob at 99,
2) A cancel by Bob
3) A sell 1 by Alice at 99.

Now the trade between Alice and Bob never happened because of the cancellation, and Alice's offer at 99 was never matched.

Is this front-running resistant? No.

This is front running. What could have happened is that Bob's node saw Alice's sell, and based on that, immediately sent his cancel before whoever made his block could see the actual sequence. The resulting sequence in the block could have just been received that way, or it could have been malicious, such as Bob himself manipulating the order. The point is that front running is a big problem for limit order books in the decentralized exchange.

For comparison, in centralized exchanges, high frequency bots are trying to figure out what's happening on the order of nanoseconds. In the decentralized exchange, they have trillions of times more time to manipulate markets.

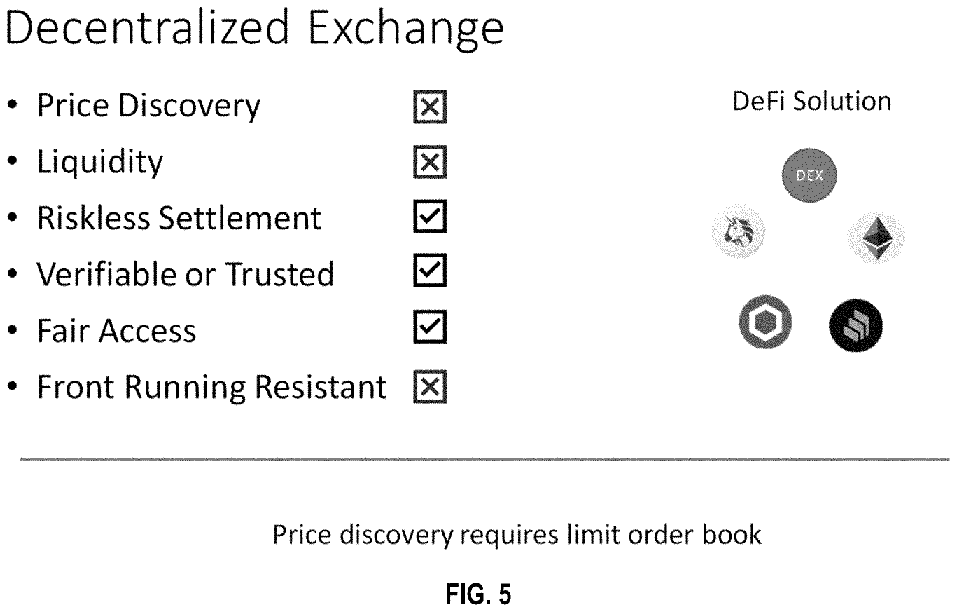

FIG. 5 shows properties of a decentralized exchange. The decentralized exchange has fair access, but it is not front running resistant. It is verifiable because it is a blockchain. Riskless settlement: when actually settling on chain using a limited order book on chain and the fills happen the profit and loss can automatically be deducted, so the exchange is riskless.

However, regarding front running, there is no price discovery. Without the price discovery there is no liquidity. As such, we have a problem. Price discovery requires limit order books, and limit order books do not work in a decentralized way because of front running. We need a new solution.

### DeFi Exchange

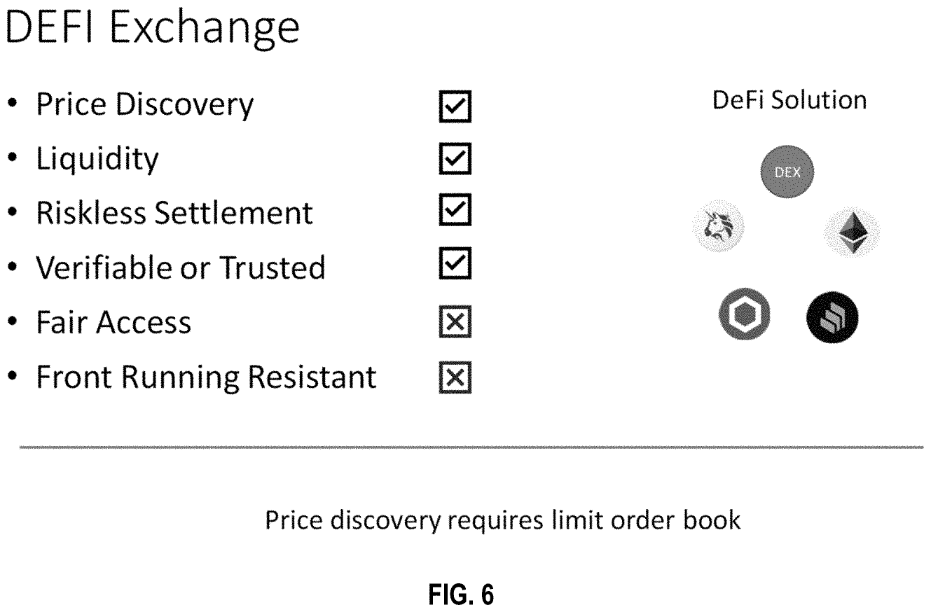

FIG. 6 shows an overview of a DeFi exchange. One attempt at this problem is a DeFi solution. We create a dexcoin and a DeFi solution and we do it on Ethereum, so we have verifiable fair access.

However, there's no limit order book in Ethereum, which is why the DeFi exchange uses Uniswap. Uniswap enables riskless settlement and liquidity, but we need more liquidity than Uniswap. So the Compound protocol is used to provide sufficient liquidity. Now we just need price discovery. There is no limit order book, so we still don't have price discovery, and we don't have front running because there is nothing to front run.

Chainlink provides oracles to external centralized exchanges, which enables price discovery. However, this means that the exchange is no longer decentralized, so there is no longer fair access. This DeFi exchange is pseudo-centralized. It relies on the oracles, and the oracles rely on the centralized exchanges, creating a big obfuscation problem.

The DeFi exchange is not front-running resistant—it's one big, complex front run. The problem is worse than for the centralized exchanges. It should be worse than the decentralized exchanges, but because it's known that decentralized limit order books have front-running problems, people are not likely to use them. For the DeFi exchange, it is less apparent that there is a problem.

### DEXchain

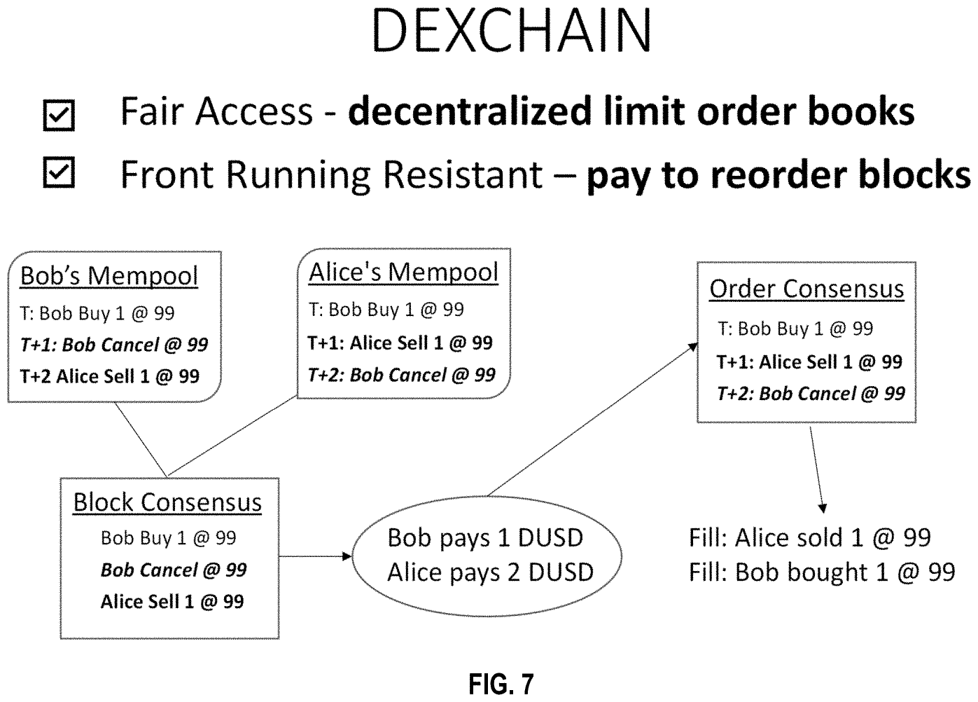

FIG. 7 shows an overview of DEXchain. DEXchain solves the two main problems of 1) fair access and 2) front-running resistance. Fair access is solved with decentralized limit order books, and the front-running resistance solution is paying to reorder transactions.

Blocks are separated into two stages. FIG. 7 shows Bob's mempool and Alice's mempool, similar to FIG. 4. Bob's mempool has his cancel first, while Alice's mempool has her sell first.

First, what's needed is a consensus on the transactions inside the mempool, without the time stamps. That is, what are the transactions in the mempool?

Next, after obtaining a consensus on all the orders over, for example, the past five seconds, how do we generate the actual order book based on this? DEXchain uses a bidding system. As shown in FIG. 7, Bob and Alice are both bidding. Bob pays one dex dollar and Alice pays two dex dollars, so Alice wins. These are implemented using similarly to addressing double spends, so only one of them is valid. Since Alice wins, she gets her order consensus, which is the buy then sell at 99, and this becomes final. Overall, Alice sold one at 99, Bob bought one at 99, and the cancel is gone as a result.

In this way, front-running is solved in the spirit of what blockchain has always done, which is opening everything up and delaying finality Everything is explicit, and nothing is hidden. If someone wants to front-run, fine—do it over here, and do it later. This removes all that gaming from the decentralized exchanges that we saw in FIG. 4 because none of that matters anymore, and so there is no front-running problem.

In addition, one of the main things that trading bots are trying to avoid is not necessarily small price drops like 99 to 98, but a flash crash. Accordingly, most of the time, the reordering described above does very little to change the state.

But every once in a while, there is a huge move—a flash crash—that comes right back up. This can be dealt with by “running it twice”, similar to in poker. Major variance that happens in a short amount of time can be analogized to the Heisenberg Uncertainty Principle, that large variance is limited to what could be dealt with a short amount of time. So the solution, in theory, is to deal with it later and run it twice. However, in practice, a flash crash should never happen because none of the trading bots need to cancel their orders because they can deal with it later through the bidding process.

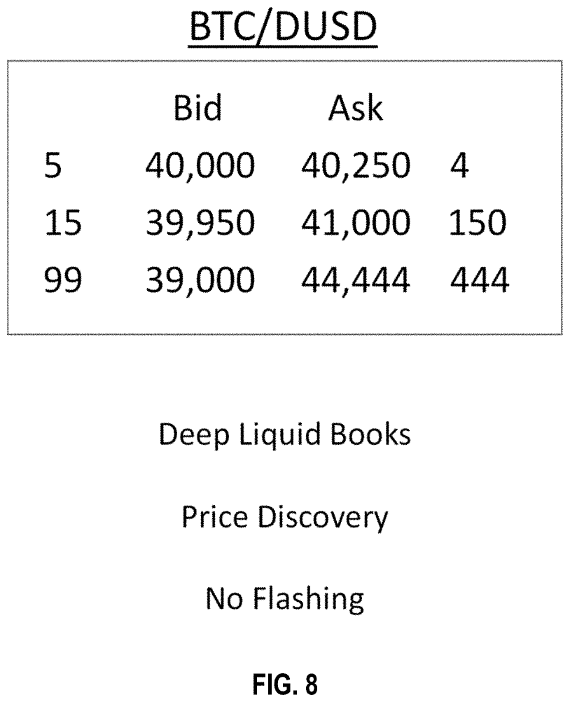

FIG. 8 shows an example exchange. There are bitcoin, dexdollars, and bitcoin futures. The exchange has deep liquid books, so instead of 0.1 bitcoin, FIG. 8 shows a bid for five bitcoin at 40,000 dollars and an ask at 40,250 dollars. This example represents a large spread, it is meant to illustrate real bids and real asks, not market manipulation. Even if someone is trying to make a scalp, they're not manipulating the book.

There is price discovery and no flashing, as there is no need for flashing. Thus, this is an iteration of a hard exchange. There is liquidity, with real bids and asks coming together to find matches. Tricks used by high frequency bots are not needed, because any advantage gained from these tricks is negated by the approach of “doing it later.” All the front-running techniques must be done later instead of live, which minimizes excess traffic.

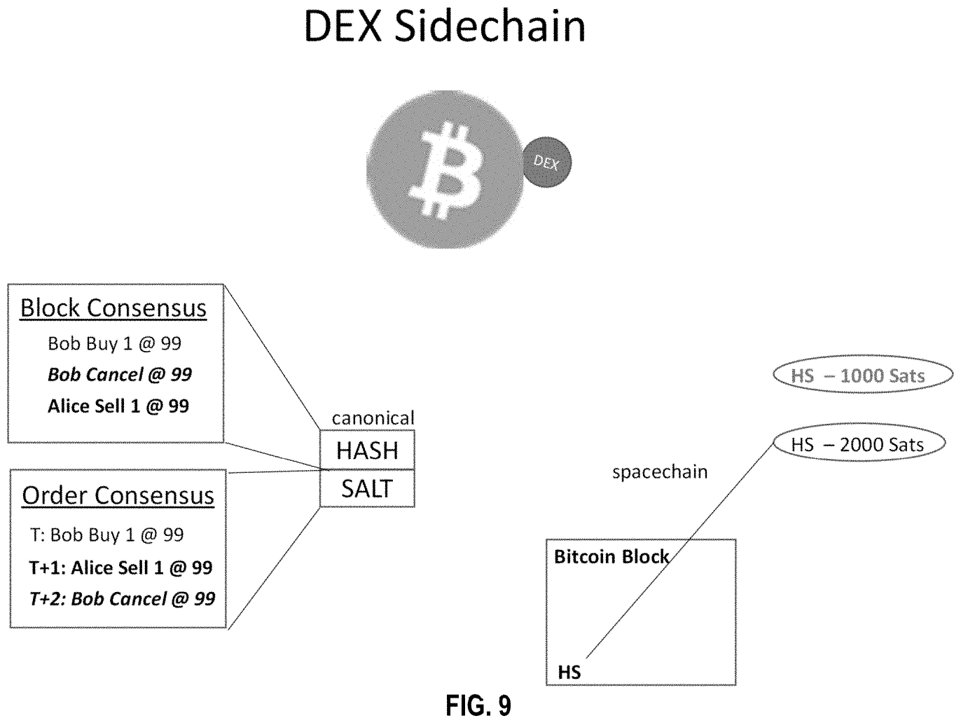

FIG. 9 illustrates DEXchain implemented with bitcoin. There is a DEX side chain and bitcoin. Block consensus happens on the side chain. For example, consensus can happen once every five seconds, and there can be 200 of these blocks. Each block is a hash, and if there is more than one block, it's the Merkle root.

There is also the salt of the order consensus. For example, FIG. 9 shows a bid of 1,000 Sats and a bid of 2,000 Sats, so the 2,000 Sats bid wins. The hash salt of the 2,000 Sats bid then goes into the bitcoin block. This is similar to the spacechain idea. The salt can be used to create the canonical ordering of the transactions within the block.

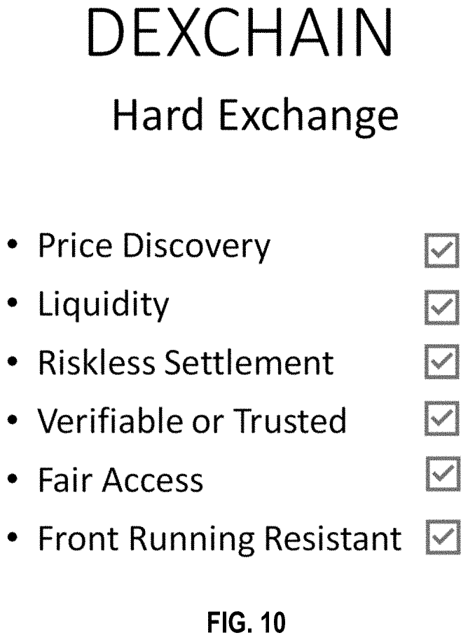

FIG. 10 illustrates the DEXchain that satisfies the criteria of a hard exchange. There is price discovery with limit order books. There is also liquidity because of price discovery with limit order books. Riskless settlement occurs on the side chain. The exchange is verifiable, especially when transactions hit the bitcoin blockchain. Fair access is present because everyone can have a node. Front-running resistance is present due to the process of reordering the transactions.

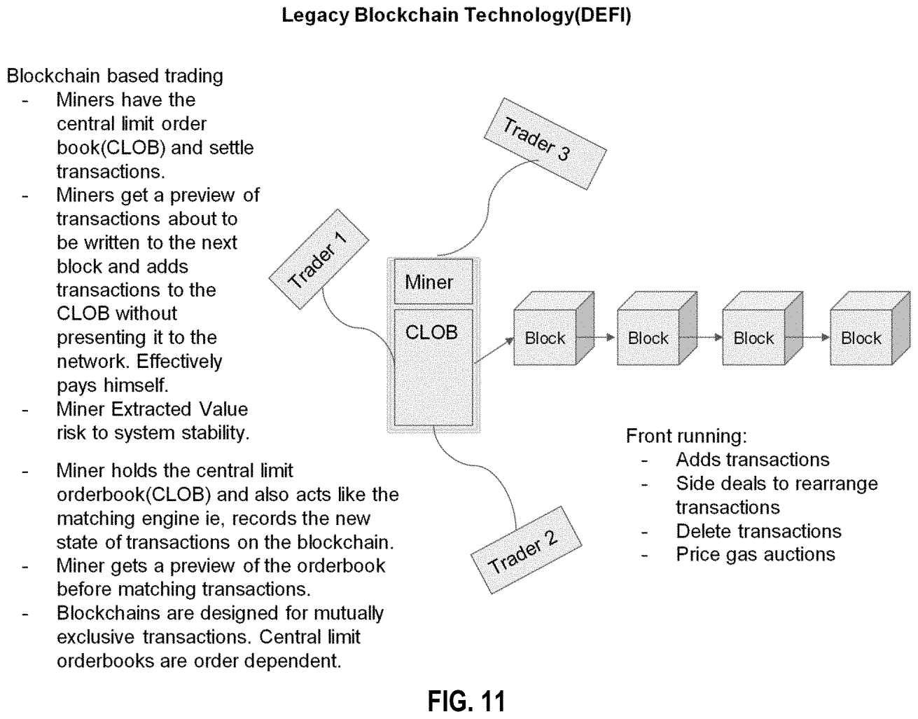

FIG. 11 shows an overview of legacy blockchain technology, such as DeFi.

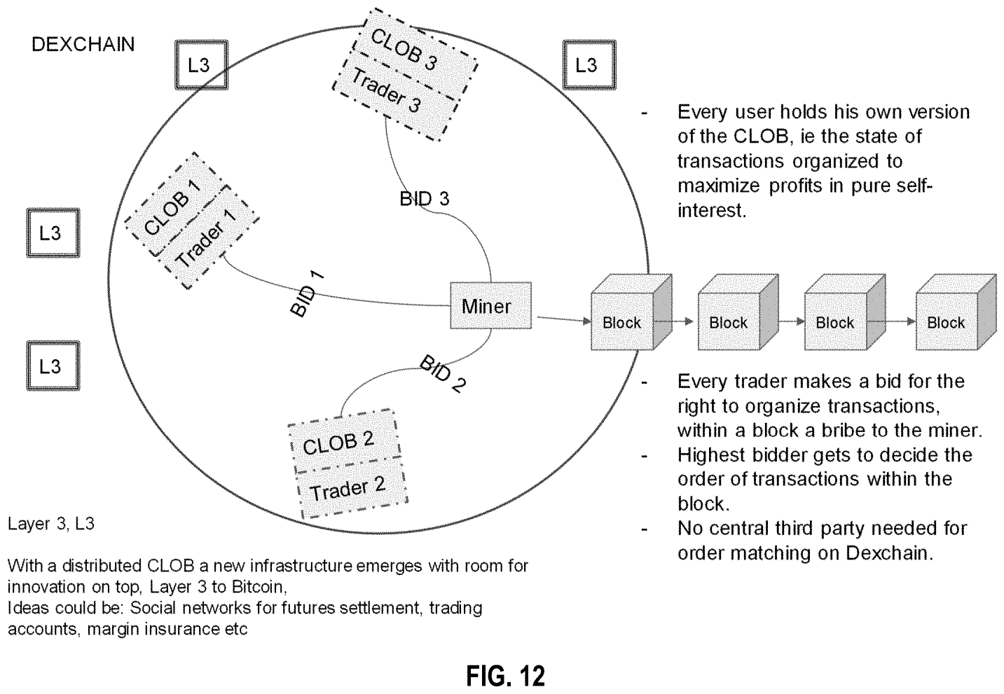

FIG. 12 shows an overview of an embodiment.

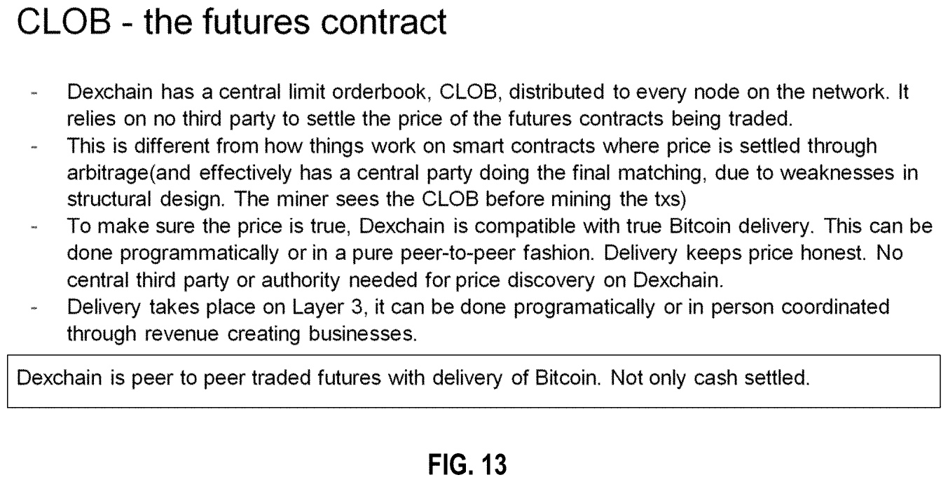

FIG. 13 shows an overview of a central limit order book of an embodiment.

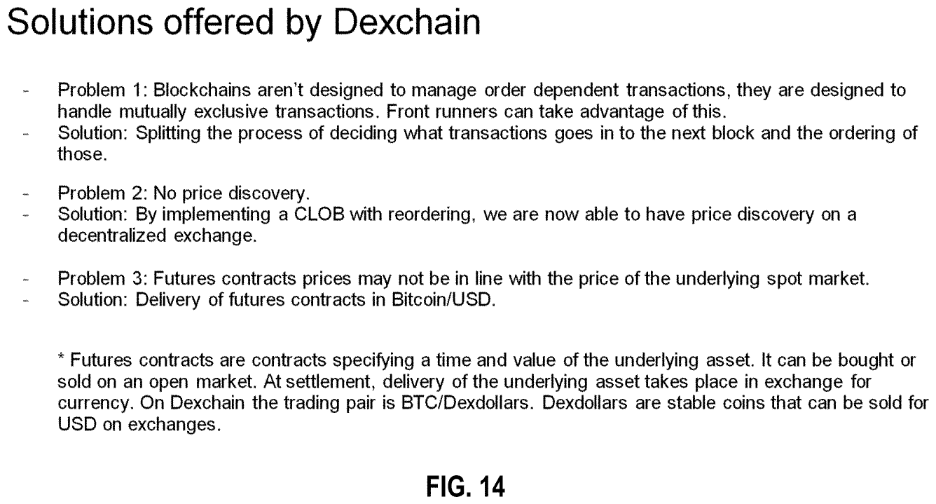

FIG. 14 shows features of an embodiment.

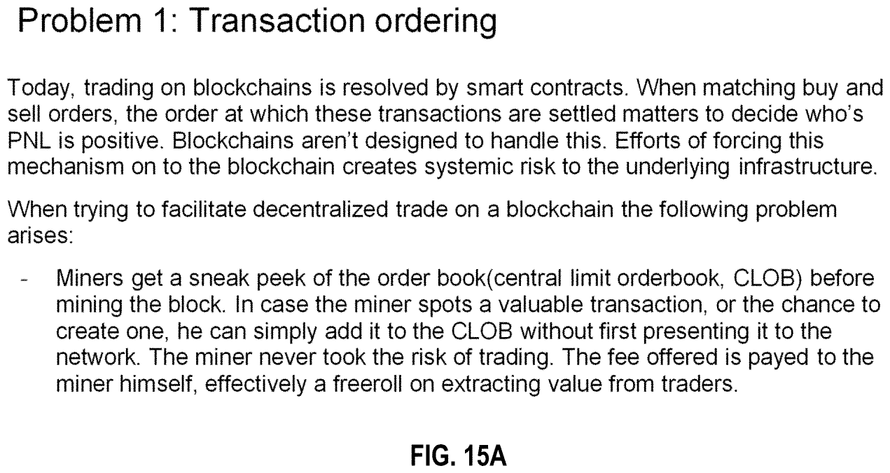

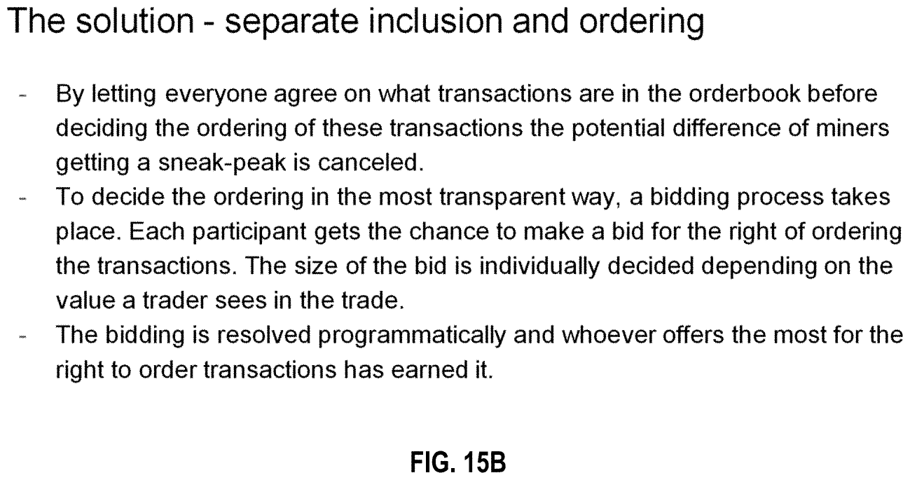

FIG. 15A shows an overview of transaction ordering.

FIG. 15B shows an overview of how transaction ordering is handled according to an embodiment.

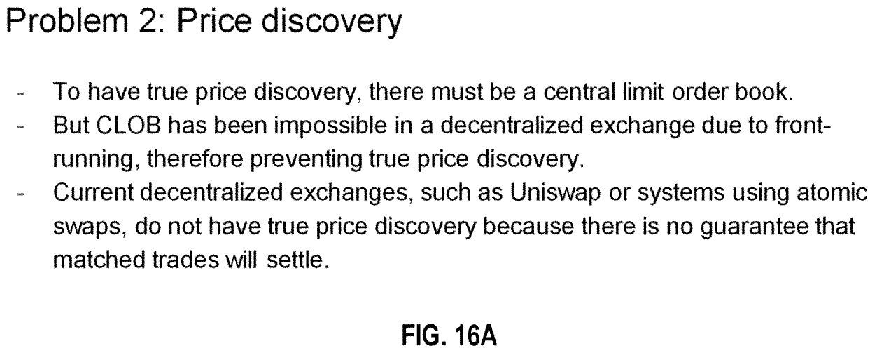

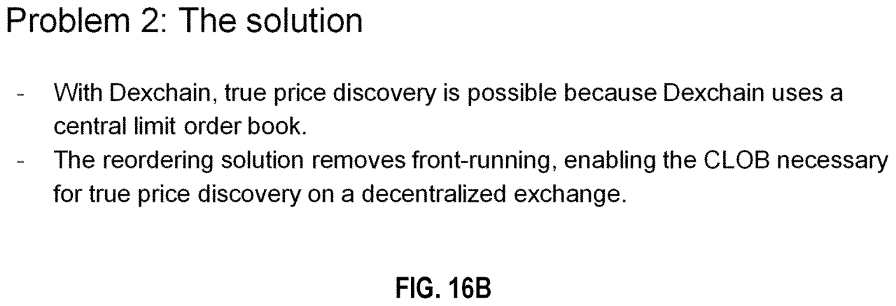

FIG. 16A shows an overview of price discovery.

FIG. 16B shows an overview of how price discovery is handled according to an embodiment.

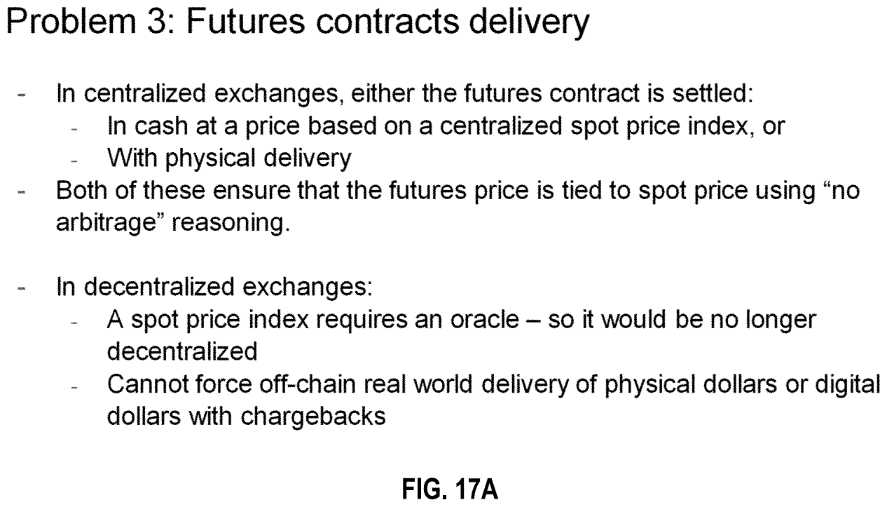

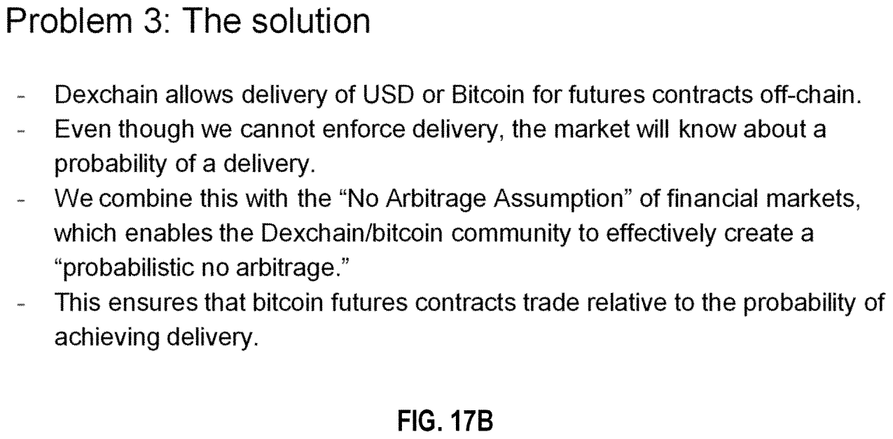

FIG. 17A shows an overview of futures contracts delivery.

FIG. 17B shows an overview of how futures contracts are delivered according to an embodiment.

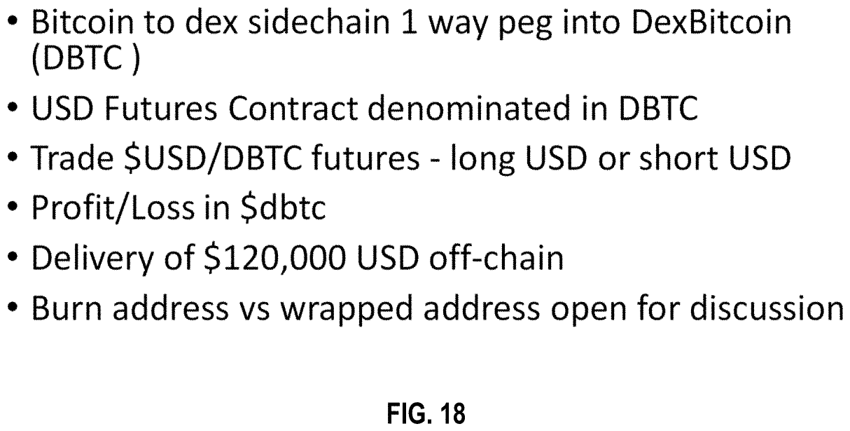

FIG. 18 shows features of DexBitcoin according to an embodiment.

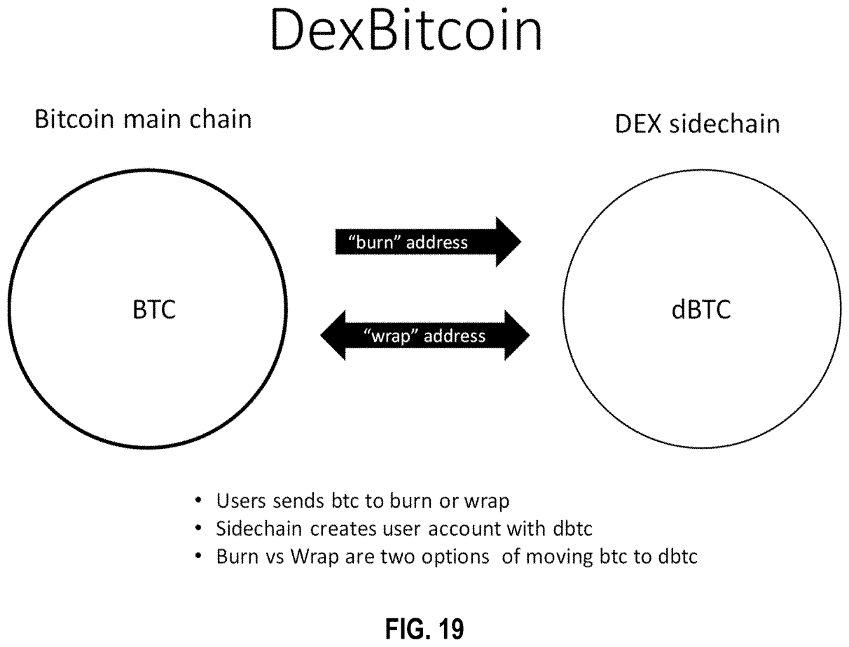

FIG. 19 shows features of DexBitcoin according to an embodiment.

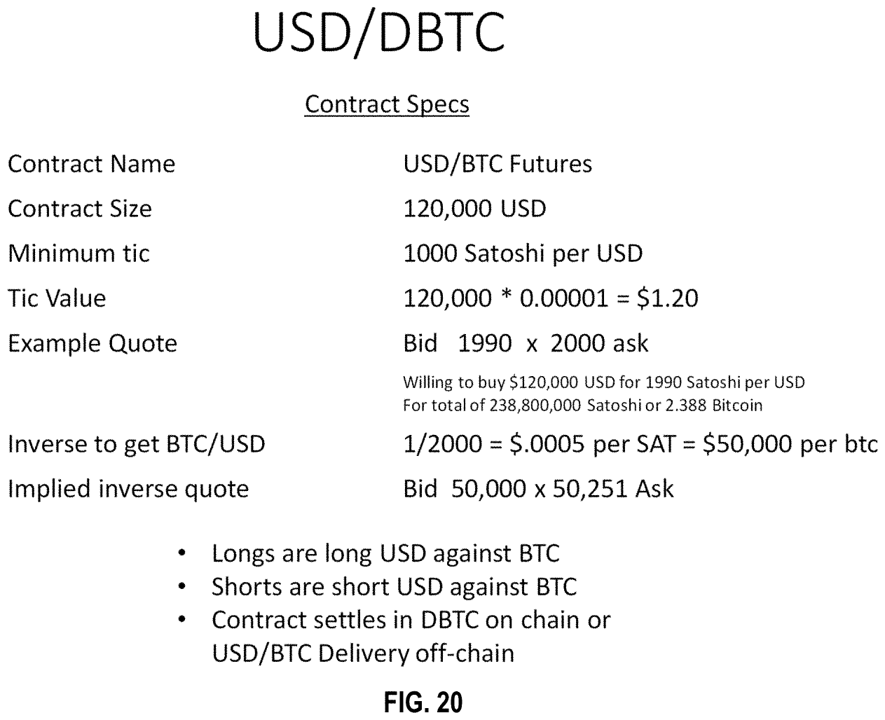

FIG. 20 shows features of DexBitcoin according to an embodiment.

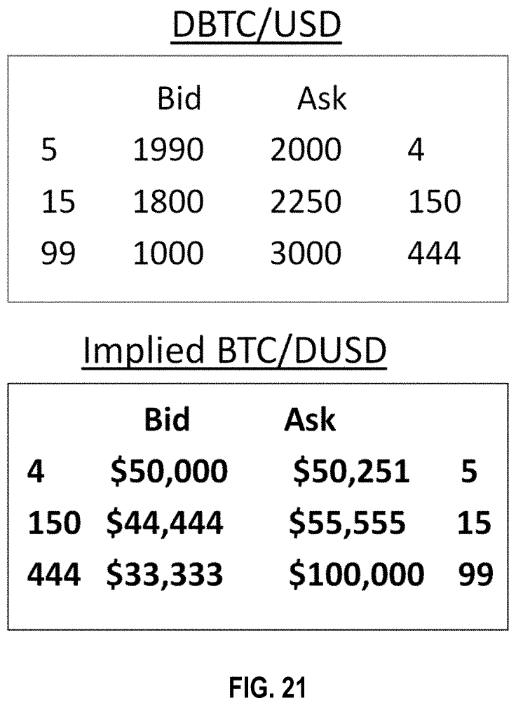

FIG. 21 shows features of DexBitcoin according to an embodiment.

### DEXchain

Additional description of embodiments relating to DEXchain is now presented. DEXchain can be described as a bitcoin sidechain with on-chain utility of hedging price risk of future coinbase cashflows for bitcoiner miners.

### Futures Contracts

Futures contracts are agreements to buy a specific commodity or asset at a specific price and time in the future. Since the actual transaction does not happen until the settlement date, the buyer does not have to pay the seller until that time. At the end of the futures contract, the buyer must pay the seller the agreed upon price, and the seller must “deliver” the commodity to the buyer.

However, before delivery time, the buyer (or seller), can close the contract by selling (or buying) to somebody else. Assuming the price of the futures contracts trade relative to the underlying commodity, these can be used to hedge risk in the underlying commodity, or to speculate with leverage.

### Futures Delivery Mechanism

The fact that futures contracts has delivery, ensures that the price of the contract trades relative to the underlying asset. This is due to the fundamental No Arbitrage Theory, where traders would otherwise earn free profits.

We propose a futures contract on bitcoin block rewards, where miners can hedge the future price of bitcoin, by locking in today's price for future block rewards.

### Players

Hedgers—miners can hedge their investment and risk against bitcoin price
Speculators—users can speculate on the price of bitcoin, with leverage, as only a small Good Faith Deposit is required to buy or write a futures contract. They can also speculate on the price of bitcoin falling.
Market Makers—can earn profits by providing liquidity to speculators and hedgers.

### DEX Sidechain

Each node will have full price-time priority limit order book and matching engine.

To implement this, the sidechain will be account based and not UTXO based. This enables the separation of the transactions from the state. It also enables explicit deterministic code, similar to smart contracts, to update account balances based on profit-and-loss from trading.

We define static transaction types and deterministic state, as implemented in protoblock, which has been running live for many years now.
Transactions
ExchangeOrder
Positions—Fills—Market Data
Matching Engine on-chain

### Virtual Co-Location

High Frequency Trading bots pay centralized exchanges millions of dollars to co-locate near the matching engines. Even a single nano second latency advantage could mean the difference between a profitable or losing operation.

As described in On Dex, all decentralized exchanges have a major front-running problem, as trading bots get to see all order before they even hit the matching engine.

Even with honest miners that do not try to to game the protocol, and just add transaction in order received, traders will attempt to locate their nodes as close to miners as possible, or even pay miners for co-location. As miners then become the equivalent of centralized exchange matching engines.

We solve this by separating block-consensus, from order-consensus. Block-consensus is consensus on which transactions to include in the block. Order-consensus is consensus on the order of processing of the transactions in said block.

### Anti-Front-Running Mechanism

After block-consensus is reached, a bidding process is used where the highest bidder determines the order-consensus. In this implementation we propose bribing of the bitcoin miners for order-consensus similar to Spacechains.

This is akin to a virtual co-location, since after the block we allow nodes to pay to reorder the transactions in the previous blocks, as if they were co-located with the miner of the previous block.

### Spacechains

Spacechains is a bitcoin sidechain, that is blind merged mined. Meaning, a single hash that corresponds to a sidechain block will be included in each bitcoin block. This is accomplished using covenant transactions and replace-by-fee, which essentially means that each block on the sidechain is “mined” by the highest bidder on the main-chain.

For our DEXchain, we use this same technique, only instead of the highest bidder deciding the contents of the next block in the sidechain (block-consensus), the highest bidder gets to decide the order the transactions in a block(s) that already reached consensus in the sidechain (order-consensus).

In the original spacechain idea, it was thought that the main-chain bid would be based on the amount of fees received on the sidechain block. It turns out, for DEXs and many other protocols, the ordering of transactions has value itself. This is sometimes referred to as Miner Extracted Value (MEV) on ethereum. So traders would bid the amount that they value this new reorder, independent or in addition to fees.

### Dexdollars

Any DEX with on-chain matching needs a token for margin and settlement, otherwise fills from matching in the order-book cannot be guaranteed. Guaranteed settlement of fills is a basic requirement for price-discovery in open markets. Atomic swaps, for example, cannot guarantee settlement, they can only guarantee no funds are lost, in case one party reneges.

Instead of creating a new alt token, we use bitcoin and convert it to dexdollars.

Similar to Ruben's spacechain, we use a perpetual one way peg (P1WP) to create tokens on the dexchain. Only instead of generating 1 token per bitcoin we generate the dollar value of 1 bitcoin, and call them spacedollars or dexdollars.

Example: A bitcoin transaction can burn bitcoin on main-chain and receive 40,000 dexdollars on the sidechain (based on bitcoin/dollar rate of $40,000).

A naive implementation would be to use some kind of price feed oracle to determine the rate. However, given the fact that our futures contract can be held for delivery of actual real bitcoin, using no-arbitrage pricing model, it turns out that the futures contract price itself will represent the going rate of $btcusd!

### Mechanism for Dexdollar/USD Stability

It could be that bitcoin sellers would charge a 20% markup for dexdollars over real usd, in this case instead of 40,000, the rate would be 50,000. The mechanism to solve this is to allow delivery to be done in real USD or USDC/USDT. Even if only 1 or 2 contracts reach delivery with honest/altruistic buyers and sellers, by them completing the bitcoin to USD swap for delivery, this would be enough to keep the futures contract and the dexdollars priced around USD.

When there are no contract sellers willing to actually deliver bitcoin, the contract is instead settled in cash dexdollars. So buy 1 contract for 10,000 dexdollars, and by settlement the contract is worth 40,000 dexdollars. In this case, the buyer gets the 40,000 dexdollars, for a 30,000 profit.

Note: over 99% of futures contract are closed before delivery. It's the option to deliver that matters.

### Dexchain Consensus

Within the DEX sidechain, there are two distinct consensus needs. 1 Preventing double-spends for dexdollar coin transfers. 2 Low-latency mempool replication with -5 second blocks for DEX ExchangeOrdertransactions.

### Coin Transfer

For dexdollar transfers, we only need to prevent double-spends, as long as the balance available to transfer is not be tied to the exchange data. This can be done by keeping the UTXO bitcoin model, with a special deposit and withdrawal address. Sending coins to deposit would burn that UTXO, and add the dexdollars to account for DEX trading. After settlement, a withdrawal would be like a new coinbase, with an output to a UTXO.

The simple implementation would be to include these transactions within the hash that will be blind-merged-mined with bitcoin. This would require waiting for at least 1 bitcoin block for a transfer.

A more realistic implementation would be to enable transfers independent of the DEX consensus. This can be implemented within a spacechain hierarchy. Bitcoin=>P1WP=>spacechain<=>P2WP<=>dexchain

### Exchange Orders via Federated BFT

Dexchain transactions pay fees in dexdollars. All transactions go into a mempool. The goal is coming to consensus on the entire mempool, every -5 seconds. There can potentially be 100 or more dexchain blocks in-between each bitcoin block.

Note that DEX nodes require “all” transactions in order to build a mempool order-book state, in order to make trading decisions and sign new ExchangeOrder transactions. In contrast to bitcoin, where nodes only really care about transactions there are a party to.

DEX Consensus Protocol (DCP), is a modified Stellar Consensus Protocol (SCP) which is a Federated Byzantine Agreement (FBA) protocol.

We borrow the ideas and consensus from Stellar.

Insight: the Internet hypothesis The Internet is a globally connected network
Structure results from individual peering & transit relationships
Decentralized decisions could have yielded many internets, but didn't
Transitively, everyone wants to talk to everyone

Hypothesis: counterparty relationships transitively converge
Clearing houses are effectively the tier one ISPs of banking

| | DECENTRALIZED | LOW | FLEXIBLE | ASYMPTOTIC |
|---|---|---|---|---|
| MECHANISM | CONTROL | LATENCY | TRUST | SECURITY |
| Proof of work | √ | | | |
| Proof of stake | √ | maybe | | maybe |
| Byzantine agreement | | √ | √ | √ |
| Tendermint | √ | √ | | √ |
| Stellar Consensus | √ | √ | √ | √ |
| Protocol | | | | |

### Motivation for Using DCP

For the secondary order-consensus to work, we first must reach consensus on the set of orders for the block-consensus
The goal is to have very fast blocks of around 5 seconds
Hypothesis: dex trader relationships transitively converge. In a DEX, trader nodes need and want to share transactions with “adversarial” nodes of other traders, in order to create a local limit-order-book for their nodes matching engine.
With low latency needs, we use a networked PBFT like protocol, which anyways relies on a semi-centralized internet overlay network
Market makers, high volume traders, and exchanges are the tier1 ISP equivalent of DEXchain

### DCP Highlights

Sybil resistant federated BFT protocol
Each Node chooses a Quorum Slice of nodes it cares about, and wants to stay in sync with
Each Node comes to consensus via a quorum election process
The safety of DCP is always known after the main-chain block. A break in safety (fork), will stop consensus and require a hard-fork to move forward. This is similar to how forks are dealt with in the spacechain proposal.
Guarantees liveliness between bitcoin blocks
Guarantees safety or failure after every bitcoin block
Liveness is guaranteed by optimistically choosing to accept the claims from nodes of your quorum slices that “their quorum slices accepted a block”. This enables nodes to continue even when their quorum failed to vote on the block, as an alternative is being permanently stuck.
   In dexchain, we are just kicking “getting stuck” down the road, to be dealt with after the order-consensus on the bitcoin main chain.
Your transaction fees can only be claimed by correct nodes in your quorum
Alternatively, transaction validity can be tied to the blocks voted on by a nodes quorum slices

### Tiered Quorum Slice

Like the Internet, no central authority appoints top tier—but market can decide on de facto tier one organizations—doesn't even require exact agreement on who is a top tier node

Eventually market forces should converge on honest, high volume, stable uptime, and well known nodes to use as tier1 for quorum slices.

We propose a decentralized explicit way of doing this on-chain, with a mechanism for initially choosing tier1 nodes. Mechanism is designed to align with the incentives of bitcoin miners participating in DEX for hedging and delivery.

### Mechanism for Broadcasting Desire to be Added to Quorum Slices

Proof of POW—special signals inside a coinbase op_return with public-keys are added to a default tier1 list
Proof of coinbase burn—creating dexdollars via a burn from virgin coinbase coins are also added to the default tier1 list
   This enables non miners to become default tier1, by buying and holding futures contracts, and taking delivery via the coinbase

This added benefit of becoming tier1 may potentially cause futures contracts to trade at a premium, thus putting upward price pressure on dexdollars relative to real dollars. This can be used in addition to Fernando Nieto's demurrage ideas to lower the “volatility of the convenience yield of the token”.

This value of being a “well-known” tier1, can also be used to disincentivize malicious nodes with slashing techniques. You lose “default tier1” status, when caught being “malicious.”

### Dexchain Protocol

Stellar Transaction Lifecycle: Crafting a candidate transaction set (Validator): When it's time to close the ledger, each stellar-core validator (a stellar-core node participating in consensus) takes all valid transactions it is aware since the last ledger close and collects them into a candidate transaction set. If it hears about any incoming transactions now, it puts them aside for the next ledger close.

### Example Embodiment: Mechanism Designed Decentralized Exchange Protocol for Permissioned Blockchain

Front running transactions in a blockchain network create Adverse Selection Risk. Empirical evidence shows this is a real problem, specifically on Ethereum. We show how this is also an issue with BFT based permissioned blockchains as well, and that many other works have started looking at these new kinds of non-byzantine manipulation attacks.

Blockchain is an attempt to abstract bitcoins underlying technology. We point out the design flaws of the main two approaches, permissioned BFT and Turing complete smart contracts platforms like Ethereum.

We show how stock exchange are the ultimate test for blockchain design, as the matching engine transactions are order dependent, and how current blockchain implementations actually create the incentives for adverse front-running.

We suggest that Bitcoin was a result of an implicit mechanism design, which takes an application specific objectives approach to designing a system using economic incentives, with the goal of designing a system that reaches a Nash equilibrium that are aligned with the applications objectives.

We propose a Decentralized Exchange protocol design using mechanism design. We show how the current High-Frequency-Trading (HFT) strategies create adverse selection risk on centralized exchanges with no front-running.

We propose a new blockchain exchange design with explicit front running. We suggest that adverse selection from transparent front-running will be a net positive and attempt to show how this may stabilize into a Nash equilibrium.

### 1. Introduction

Distributed Exchanges (DEX), will tackle the biggest blockchain technical challenges, decentralized limit orderbook matching engines, in the biggest market, global stock exchanges.

With a new take on the blockchain abstraction that underlies bitcoin. Bitcoin, the breakthrough peer-to-peer electronic cash protocol, which for the first time solved a slice of the long-standing impossibilities in distributed computing.

Algorithmic game theory married computer science and Nash equilibriums, while mechanism design is the technique of designing something new and unique by setting up a base for natural equilibriums to emerge that practically gives the distributed computer algorithms explicit assumptions which are guaranteed when human actors are also in equilibrium with other human actors. Human actors include the users, developers, and centralized providers.

We propose that Bitcoin is an implicit mechanism design, and we infer the mechanisms in this paper. Bitcoins C++ code use a 1 line zero knowledge proof to assume that

F (block)<target==true

implies that an immutable censorship resistant consensus of the human actors, chose this miner via a guaranteed sybil proof random drawing. This assumption is made by all nodes independently at their own pace. This is bitcoins use of proof-of-work consensus.

We say practically, because this is all only probabilistic, since the impossibility proof still holds, due to Heisenberg uncertainty principle we just need to use time to give us the practical finality.

We say that the transparency and time is all we need to reach a Nash equilibrium of the humans who have an explicit vested interest in the system.

This brings the providers, users, coders, governments, developers, engineers, sales, writers, etc. into equilibrium with the required assumptions for the strong guarantees of the distributed software algorithms.

The basic mistake with abstracting bitcoin to PBFT, was that Byzantine Faults are only relevant when all nodes are controlled by the same Alice. Bitcoin is for Alice to send Bob cash.

The basic mistake of abstracting the bitcoin script into turning compete scripting languages like Ethereum, is that the latter is meant to enable Alice or Bob, to upload arbitrary bytecode which may enable any action on any kind of distributed algorithm, with the same strong assumptions guaranteed to the former.

We abstract blockchain into a mechanism design pattern. We then apply this technique to architect DEX, a permissioned distributed matching engine, which fixes the adverse selection flaw in SBFT from front running. See FIGS. 1A and 1B.

We find mechanisms using time and transparency, and patterns of inversions emerge which follow the history of innovations in distributed computing which includes blockchain technology.

We see blockchain technology as a new computer science.

Contributions. To summarize, our work has the following contributions:
We abstract Blockchain as a design pattern in Distributed Algorithmic Mechanism Design (DAMD)
We infer mechanisms from Bitcoin, based on the notion that Satoshi implicitly used DAMD
We define Decentralize Exchange (DEX), its mechanisms, design, and protocol.

Organization. The rest of the paper is organized as follows. Section 2 provides background on bitcoin, blockchain, stock exchanges, and the front-running problem. Section 3 describes our new mechanism design blockchain abstraction. Section 4 details a new Decentralized Exchange (DEX) Protocol.

### 2. Background

### 2.1 Bitcoin

Bitcoin combined triple entry accounting linked time-stamps and Proof-of-Work to solve the double-spend problem in peer-to-peer electronic cash.

Signed Transactions: A bitcoin transaction that transfers bitcoin from Alice to Bob, will contain an input digitally signed by Alice which unlocks the coins, and an output, to an address of Bobs which locks the coins. For example, a bitcoin address is derived from a public-key.

Gossip Network: Bitcoin is a distributed peer-to-peer network, where nodes continuously gossip about transactions, enabling each node to maintain a cryptographic secure ledger with history of all bitcoin transactions, and the current state, the Unspent Transaction Outputs (UTXO)

Double Spend Problem: Intuitively, digital cash through the internet, seems impossible, because any bits that act like cash, can be copied and spent to multi-parties simultaneously. When Bob receives bitcoin from Alice, how can he know that they didnt already transfer the same bitcoin to a third-party?

Bitcoin Blockchain Solution: Bitcoin transactions are stored in blocks, with each block-header containing a reference to the sha256 hash of the previous block, making up a Blockchain. Blocks are verified by each node, and only valid transactions are stored in each block. Since only one of the double-spend transactions is valid, a block that contains one of the competing transactions automatically makes the other one invalid.

Proof-of-Work (POW) Consensus: Only valid blocks can be appended to the blockchain. According to the protocol rules, blocks are only valid if the sha256 hash of the block has N number of leading zeros. For example, N changes every 266 blocks to maintain an average of 10 minutes for a miner to find the block.

sha256(Block)<=target

Miner Incentives: Miners receive bitcoin as a reward when a new block is accepted. Since the sha256 hash is a one-way function, the only way to find a valid block is by iterative brute force. Miners add extra data to the block, called a nonce, and iterate until a valid block is found. This process is called bitcoin mining.

Nakamoto Consensus: Also known as longest chain rule, is a protocol rule that measures the total work done on the chain, and only the chain with the most work is used. Since mining is a costly and competitive process, the incentive is to only work on the chain that will be excepted by the network.

### 2.2 Blockchain Abstraction

### 2.2.1 Ethereum

Ethereum blockchain added a Turing complete virtual machine for writing smart contracts, so in addition to merely transferring coins, like Bitcoin, any arbitrary code can be uploaded and executed on Ethereum. This enabled the development of many kinds of distributed applications (DAPPS), now running on top of Ethereum, including other crypto tokens, as well as distributed exchanges (DEX).

### 2.2.2 Permissioned Blockchain

Permissioned blockchains are protocols among a selected consortium of trusted nodes. This removed the need for energy intensive POW mining. Instead, Byzantine Fault Tolerant (BFT) consensus mechanisms, such as SBFT are used. These 20+ year old techniques in distributed computing, ensure all honest nodes process all transactions in the same order, which also prevents double spends.

Furthermore, enterprise permissioned blockchains enable smart contract to be executed, which opens the system up to arbitrary DAPPS.

### 2.3 Stock Exchanges

We use the generic Stock Exchange to refer to any electronic exchange were buy and sell orders are matched based on price and time preference.

Limit Order Book: Buy and Sell orders that are below and above the market respectively create standing bid and asks. See Table 1

TABLE 1
Limit Order Book

| 1. Alice-″Buy 1 @ 100″ | | | |
|---|---|---|---|
| 2. TraderX-″Sell 1 @ 105″ | | | |
| qty | bid | ask | qty |
| 1 | 100 | 105 | 1 |

Orders that are not matched, are held in what is called a Limit Order Book. These are the live bids and asks across all prices for this asset. This is technically called the “central limit order book”, after the distributed systems coders ran into Byzantine Generals Problems in the 80's and 90's.

Alpha: We present the basic fundamental Alpha in what is called, “High Frequency Market Making”, to illustrate the importance of canceling and how it relates to front-running, adverse-selection risk, and latency.

The orderbook now looks like Table 1

| 3. TraderY-Buy 1 @ 100 | | | | | |
|---|---|---|---|---|---|
| 4. TraderZ-Buy 1 @ 100 | | | | | |
| | qty | bid | ask | qty | |
| | 3 | 100 | 105 | 1 | |
| | qty | bid | ask | qty | |
| Alice | 1 | 100 | 105 | 1 | TraderX |
| TraderY | 1 | 100 | | | |
| TraderZ | 1 | 100 | | | |

Inside Book

Claim Assuming all orders are for 1 share, and that Alice can act after every single order, they now have Alpha, Their Expected Value (EV)>0. They have achieved the impossible, a free arbitrage.

### Proof

EV=ΣP(Xᵢ)

Alice can cancel their order for $0 profit, or they can get filled at 100.

(X₁)=$0

If Alice get filled, they are now Long at $100, so they immediately place a sell order at $101

| 3. | | | TraderX-Sell 1 @ 100 | | |
|---|---|---|---|---|---|
| 4. | | | Filled @ 100-Alice | | |
| | | | is now Long @ 100 | | |
| 5. | | | Alice-Sell 1 @ 101 | | |
| qty | | bid | ask | qty | |
| 2 | | 100 | 101 | 1 | |
| | | | 105 | 1 | |
| | qty | bid | ask | qty | |
| TraderY | 1 | 100 | 101 | 1 | Alice |
| TraderZ | 1 | 100 | 105 | 1 | TraderX |

Inside Book

Alice waits to either get filled at $101 for a $1 profit

(X₂)=$1

Or as soon as there is only 1 share left at $100, Alice will Sell 1 at $100 for a $0 profit

(X₃)=$0

TABLE 2
TraderZ Adverse Selection

| 7. | | | TraderY Cancel or Filled | | |
|---|---|---|---|---|---|
| | qty | bid | ask | qty | |
| TraderZ | 1 | 100 | 101 | 1 | Alice |
| | | | 105 | 1 | TraderX |

| 8. | | Alice Sell @ 100 | |
|---|---|---|---|
| 9. | | Filled TraderZ @100- | |
| | | Alice is now flat with $0 | |
| 10. | | Alice Cancel @ 101 | |
| qty | bid | ask | qty |
| | | 105 | 1 |

Alpha Cancel

EV=P(0)+P(1)+P(0)

EV=P(1)>=0

Here Alice is a High Frequency Market Maker, only taking +EV trades, while TraderZ just experienced Adverse Selection, i.e. their buy order only gets filled when their limit order is stale.

### Adverse Selection

Adverse Selection (AS) has been well studied and defined in relation to traditional centralized exchange traders. AS is when their order to buy, sell, or cancel is only executed when its not in your best interest, and is never filled, when there is a clear profit. Numerical models suggest that cancelations is the optimal strategy to avoid AS, and that cancelling and reinserting the same order is an optimal implementation. Empirical evidence confirms that almost half of all cancelations are resubmitted within 1 millisecond.

Prior work also shows how speed is directly related to profits by reducing AS, and the profitable response times is in the order of microseconds.

Information Technology: In addition to speed, HFT make profits from information technology, by modeling the order imbalances of the large institutions. Studies show the overall market-quality improves when HFT profits from being informed, and declines when they profit from speed.

### 2.4 Blockchain Front Running

Front-running is when an adversary sees an honest transaction on the network, and based on that information creates a new transaction in an attempt to beat the original transaction to processing. See FIGS. 1A and 1B.

Blockchains by design are decentralized with asynchronous transactions, meaning even honest nodes will sometimes receive transactions in different orders. So when a protocol is order dependent, front-running attacks are possible.

### Ethereum Evidence

Eskandari et al. detail the theoretical problems of front-running on Ethereum smart contract limit order book, and describe cancelation grief, for when a cancel transaction is front-run and the original order gets executed.

With empirical evidence of front-running on Ethereum, and concluding that this “poses a realistic threat to Ethereum today”.

Luu et al. suggest that Transaction-Ordering Dependence is an anti-pattern, and others highlight incentive and ordering attacks in POW blockchains.

Other works discussing front-running in blockchain markets.

### Permissioned BFT Faults

While the research on front running attacks in permissioned BFT blockchains is not explicit, many recent works are finding new attacks and faults that do not seem to be mitigated with BFT models.

We later suggest that a fundamental flaw in Permissioned BFT Blockchains, make them impractical for a large set of applications, namely, multi-party competitive protocols.

Others have described new types of non Byzantine attacks or faults:
Rational Users
Alive-but-corrupt
Rational Manipulation
Covert Adversaries
Byzantine-Altruistic-Rational (BAR)

### 2.5 Algorithmic Game Theory

Pre-dating blockchain, algorithmic game theory uses computer science to model complex game dynamics for Nash Equilibriums. Lie et al, has an in-depth paper on Game Theory in Blockchain, with in depth insight into its application to Permissioned blockchains.

### 2.6 Mechanism Design

Mechanism design inverts algorithmic game theory. Where mechanisms are used to design systems and protocols, where actors reach Nash Equilibriums which are in-line with specific objectives.

Most interesting to us is Distributed Mechanism Design applied to Blockchain. Its been used to study centralization issues in blockchains, and miner incentives. A recent blog post by Alex Evans, gives a comprehensive overview on Mechanism Design for Blockchain, including The Revelation Principle as well as Vickrey-Clarke-Groves auctions.

### 3. A New Blockchain Abstraction

In this section we will briefly look at the mechanisms of bitcoin. We introduce the notion that Satoshi Nakamoto, the creators of Bitcoin, implicitly used Distributed Algorithmic Mechanism Design when designing Bitcoin.

Distributed Algorithmic Mechanism Design (DAMD): Primary objectives of Bitcoin is to enable a censorship resistant electronic cash. The main technical hurdle is preventing double-spends.

### 3.1 Bitcoins Mechanisms

Node Centric Bitcoin is node centric. The C++ code running the node contains everything that is needed to reach Consensus. Nodes coded to looking out for their self-interest, seem to reach equilibrium.

Transparency From digital timestamping to Bitcoin, a common theme in the history of innovation in blockchain is the use of transparency. Everyone sees everything by default.

Multi State Nodes Distributed Synchronization is still impossible, due to the speed of light. The most natural effect of this, is each node keeping a real-time state, and a “committed” state. Bitcoin uses the Mem Pool and the Blockchain.

Reversible State Switching, reorganizing, and in general dealing with multiple states, require that the states are reversible. Bitcoin has a small set of transaction types, with a simple script. Unlike a Turing complete virtual machine, like Ethereum.

Explicit/Intentional Transaction Types Explicit transactions that the human users can reason about, seems to enable Antifragility, as we shall see with the Finality Curve

Finality Curve. Bitcoin solves the Byzantine Generals Problem, by accepting that there is never is 100% finality, there is always a slight probability that the chain will fork and “reorg”. See

Social Fork Equity. We define the area between finality and the Probability of finality as the Social Fork Equity. If an improbable event happens that technically reverts all of Bitcoins history, the humans may choose a social fork.

The ultimate security feature of a blockchain network is the ability to fork and rewrite the past. This may sound sacrilegious to some, but in practice, all blockchain networks are run by and for the humans, and when 100% of them agree to change the protocol, the protocol gets changed. In fact, when a core bug is found in Bitcoin, the bug is immediately fixed, and they don't even call it a hard fork.

“A future consensus hard fork, is part of today's consensus rules”

The design flaw of smart contracts in top of Ethereum, is that when a catastrophe happens due to a bug in the code, and there is 100% consensus of the human users to revert or fork, it is still not possible, unless there is also consensus on the main Ethereum chain itself, like it was during the DOA hack.

### 4. Decentralized Exchange

DEX is a permissioned blockchain framework for a consortium of exchange members.

### 4.1 Design

Primary objectives of DEX is to create price discovery, lower trading fees, enhance transparency, create a fair level playing field, prevent front-running, minimize Adverse Selection Risk, and encourage traders to place true order without fear of manipulation. For example, by removing speed advantages from colocation.

### 4.2 DEX Mechanisms

We borrow proven mechanism from Bitcoin and add domain specific ones.

Node Centric Each node should be self-sufficient, and customized in its own best interest of positive Alpha, and is designed to reach equilibrium as long as they follow the protocol rules.

Transparency Everyone sees everything by default.

Multi State Nodes Each node keeping a real-time state in its mem-pool for real-time trading, and then merging with the “committed” state after a new block.

Reversible State A small set of transaction types, and a finite state machine with deterministic state transitions.

Explicit/Intentional Transaction Types Create Antifragility with transactions that the human users can “reason about” its intentions. For example, opposite of “code is law.”

Finality Curve that increasingly costs more money to revert, creating practical finality.

Vickrey (Second-Price) Auction for bidding on block-reordering.

Commit-Reveal Scheme to prevent adverse-selection from auction manipulation.

Algorands Secret Cryptographic Sortition to create random block closing times, to prevent last moment Front-Running

### 4.3 Protocol

Each member is identified with a public key. The members form a physical network. Each node of the network is controlled by a single member.

Each node runs full exchange matching engine (EMA) and maintains its own limit-order-book (LOB). The EMA processes orders, updates the LOB. and generates Executions or fills.

Following two transaction types are processed by EMA:
new-order a buy or sell with a price and quantity
cancel-order a request to cancel a given order-id (OD)

Network Propagation techniques are used to ensure all nodes receive all messages. The order of the transactions for each node will be different due to the asynchronous nature of the messages.

Nodes will maintain multiple states at once. A real-time state in its mem pool, and a final state from committed blocks of transactions.

Unordered Blocks. Every N second a block is created by a selected node. The node creates a block of transactions from their mempool. A Proof-of-Stake like process is used to determine the next block producer, but more interestingly is that the N seconds changes on each block. This prevents adversaries from creating adverse selection by timing it to bet the last transaction in a block.

The number of seconds, N, is deterministic yet secret to everyone but the block signer, using the Algorands secret cryptographic sortition, technique. A proof of correct time for the block is included in each block, and verified by all nodes.

Finalizing Blocks, is done using a Vickrey auction, with a reveal-commit technique.

1. Each node may rearrange the order of the transactions in proposed unordered-block, to create a block-proposal.

2. Included in the proposal transaction is a bid amount of money he is willing to pay for this ordering.

3. A commit hash of the block-proposal is then broadcasted.

4. After receiving a commit hash from all nodes, a reveal of the block-proposal is made.

5. The block-proposal with the highest bid amount becomes the next final-block

6. The node with the highest bid, pays the amount of the seconds highest bidder.

This Vickrey (Second-Price) Auction is shown to create honest bids, and is a foundation of mechanism design theory.

### 4.4 Evaluation

With front-running explicit, and no speed or latency advantage, traders are incentivized to use Information Technology to make profits from informed trades.

Full transparency plus Vickrey Auction adds a unique twist to price discovery.

While the protocol has been mechanism designed to reach a Nash equilibrium, we can only know if this holds, once it is built and live tested in real markets.

### 5. Future Work

The question is, given the ability to reorder the past seconds transactions, how would that change the trading strategy of market participants? One possible suggested outcome may be the elimination of Flash Crashes.

Other areas to work on are the algorithmic complexity of finding a “best” ordering of transactions. If a stable solution is found, one can envision a pay for compute service. Using artificial intelligence for finding this solution is also on the future path.

A real-world test of human actors with real money online would be needed to fully test our mechanisms, and prove or improve our assumptions.

Formally defining and tokenizing Social Fork Equity to use for consensus on Weak Subjectivity in Proof-of-Stake, is another avenue for research.

### 6. Conclusion

Blockchain as a pattern for Mechanism Design is a natural and direct fit. We designed and modeled a proposed Decentralized Exchange for permissioned blockchain that has the potential to solve many of the long-standing problems with centralized exchanges, including the perceived unfair speed advantage by a select few market participants.

DEX is a promising and unique solution to the problems of adverse selection from front-running in decentralized exchanges today.

From the foregoing, it will be appreciated that specific embodiments of the invention have been described herein for purposes of illustration, but that various modifications may be made without deviating from the scope of the invention. Accordingly, the invention is not limited except as by the appended claims.

What is claimed is:

1. A method comprising:
receiving, on a main chain, a block including a plurality of transactions;
determining, on a side chain, the order of the transactions in the block based on a bidding process; and
delivering an amount of currency based on the order of the transactions.

2. The method of claim 1, wherein the currency is Bitcoin.
